(19) United States
(12) Patent Application Publication
(10) Pub. No.: US 2014/0160200 A1
(43) Pub. Date: Jun. 12, 2014

(54) INKJET PRINT HEAD

(71) Applicant: SAMSUNG ELECTRO-MECHANICS CO., LTD., Suwon (KR)

(72) Inventors: Byung Hun KIM, Suwon (KR); Hwa Sun LEE, Suwon (KR)

(73) Assignee: SAMSUNG ELECTRO-MECHANICS CO., LTD., Suwon (KR)

(21) Appl. No.: 13/773,786

(22) Filed: Feb. 22, 2013

(30) Foreign Application Priority Data
Dec. 12, 2012 (KR) 10-2012-0144336

(51) Int. Cl. B41J 2/19; B41J 2/14

(52) U.S. Cl. CPC B41J 2/19; B41J 2/14
USPC 347/40

(57) ABSTRACT

There is provided an inkjet print head, including: a first pressure chamber connected to a first channel and including a first nozzle formed therein; and a second pressure chamber connected to a second channel and including a second nozzle formed therein, the second nozzle being connected to the first pressure chamber.

### CROSS-REFERENCE TO RELATED APPLICATIONS

This application claims the priority of Korean Patent Application No. 10-2012-0144336 filed on Dec. 12, 2012, in the Korean Intellectual Property Office, the disclosure of which is incorporated herein by reference.

### BACKGROUND OF THE INVENTION

1. Field of the Invention

The present invention relates to an inkjet print head, and more particularly, to an inkjet print head capable of effectively alleviating generation of micro-air-bubbles during discharging of ink.

2. Description of the Related Art

An inkjet print head may print a desired shape or pattern by discharging micro-sized ink droplets (or other industrial liquid materials) through a nozzle.

However, the inkjet print head has a disadvantage in that discharge performance thereof is degraded due to use over a long period of time. For example, since foreign objects or air bubbles contained in ink interrupt the discharge of the ink through the nozzle, they may degrade discharge efficiency of the inkjet print head.

Therefore, development of an inkjet print head capable of decreasing degradation in performance thereof due to foreign objects or air bubbles contained in ink is required.

Examples of the related art inkjet print head are disclosed in Patent Documents 1 and 2. Patent Document 1 is provided to increase an aggregation degree of nozzles and discloses a configuration in which two pressure chambers are disposed vertically. However, Patent Document 1 fails to disclose a configuration for removing foreign objects or air bubbles contained in the ink. Meanwhile, Patent Document 2 discloses a circulation structure of ink. However, since Patent Document 2 only conceptually describes the circulation structure of an inkjet print head, it would be difficult to be substantially applied to the inkjet print head in practice.

### RELATED ART DOCUMENT

(Patent Document 1) JP2011-148276 A
(Patent Document 2) JP2012-011653 A

### SUMMARY OF THE INVENTION

An aspect of the present invention provides an inkjet print head capable of efficiently removing air bubbles generated during discharging of ink or maximally alleviating a phenomenon in which air bubbles are generated during discharging of ink.

According to an aspect of the present invention, there is provided an inkjet print head, including: a first pressure chamber connected to a first channel and including a first nozzle formed therein; and a second pressure chamber connected to a second channel and including a second nozzle formed therein, the second nozzle being connected to the first pressure chamber.

The first nozzle and the second nozzle may be disposed on the same vertical line.

The second nozzle may have across sectional area larger than that of the first nozzle.

The second nozzle may include a plurality of holes.

The second pressure chamber may have a volume larger than that of the first pressure chamber.

The second pressure chamber may have a height greater than that of the first pressure chamber.

The first channel may be connected to an ink inlet supplying ink, and the second channel may be connected to an ink outlet recovering the ink.

The inkjet print head may further include an actuator generating driving force in the second pressure chamber.

The first pressure chamber may be provided with one or more resistive structures so as to block ink from flowing backwardly in a direction of the first channel.

According to another aspect of the present invention, there is provided an inkjet print head, including: a first pressure chamber including a first nozzle formed therein; and a second pressure chamber connected to a first channel and a second channel and including a second nozzle formed therein, the second nozzle being connected to the first pressure chamber.

The first nozzle and the second nozzle may be disposed on the same vertical line.

The second nozzle may have across sectional area larger than that of the first nozzle.

The second nozzle may include a plurality of holes.

The second pressure chamber may have a volume larger than that of the first pressure chamber.

The second pressure chamber may have a height greater than that of the first pressure chamber.

The first channel may be connected to an ink inlet supplying ink, and the second channel may be connected to an ink outlet recovering the ink.

The inkjet print head may further include an actuator generating driving force in the second pressure chamber.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is an exploded perspective view showing an inkjet print head according to a first embodiment of the present invention;

FIG. 2 is an assembled perspective view of the inkjet print head shown in FIG. 1;

FIG. 3 is a cross-sectional view taken along line A-A of FIG. 2;

FIGS. 4 through 6 are views showing an ink discharging process of the inkjet print head shown in FIG. 1;

FIG. 7 is a cross-sectional view showing an inkjet print head according to a second embodiment of the present invention;

FIG. 8 is a cross-sectional view showing an inkjet print head according to a third embodiment of the present invention;

FIG. 9 is a cross-sectional view showing an inkjet print head according to a fourth embodiment of the present invention;

FIG. 10 is a plan view of part B shown in FIG. 9;

FIG. 11 is a cross-sectional view showing an inkjet print head according to a fifth embodiment of the present invention;

FIG. 12 is a plan view of a lower substrate shown in FIG. 11; and

FIGS. 13 and 14 are cross-sectional views showing an inkjet print head according to a sixth embodiment of the present invention.

### DETAILED DESCRIPTION OF THE EMBODIMENTS

Hereinafter, embodiments of the present invention will be described in detail with reference to the accompanying drawings.

The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions of components may be exaggerated for clarity, and the same reference numerals will be used throughout to designate the same or like components.

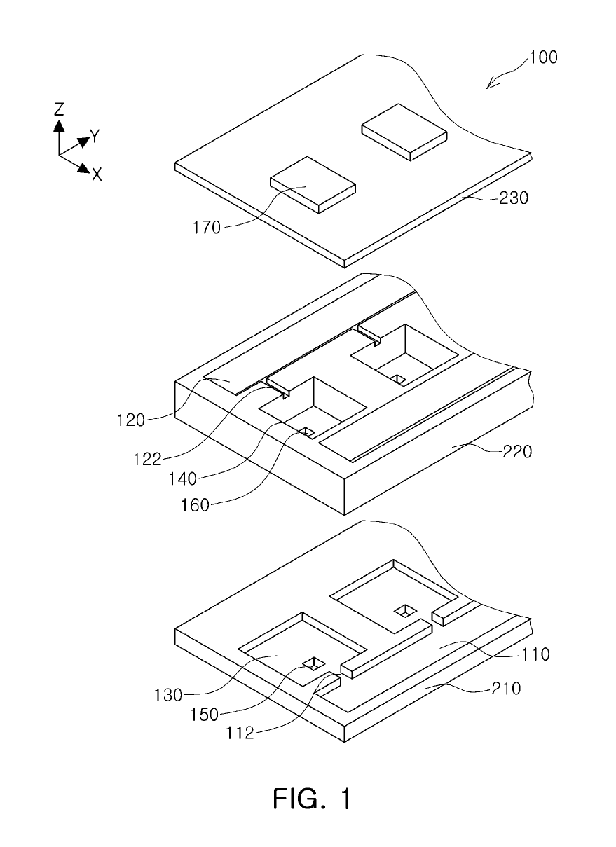

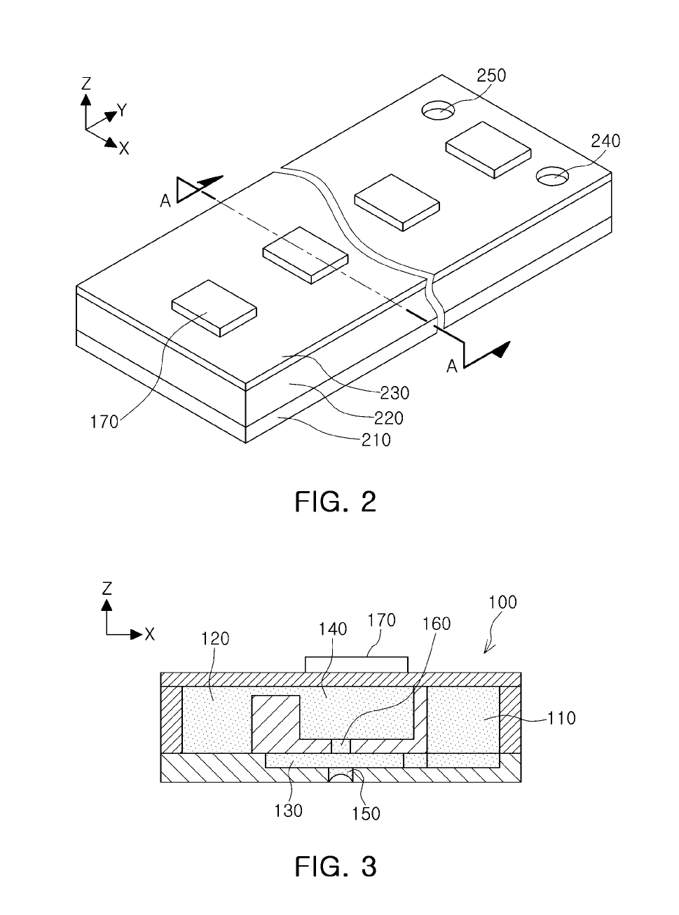

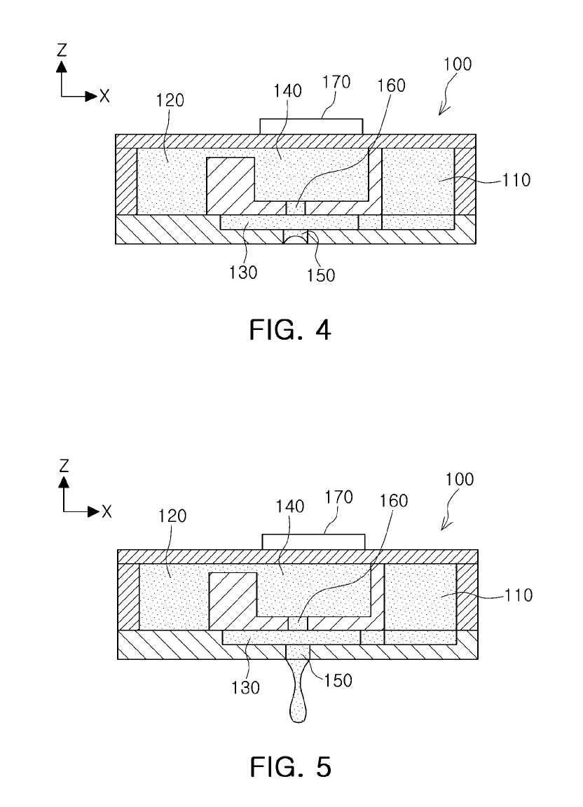

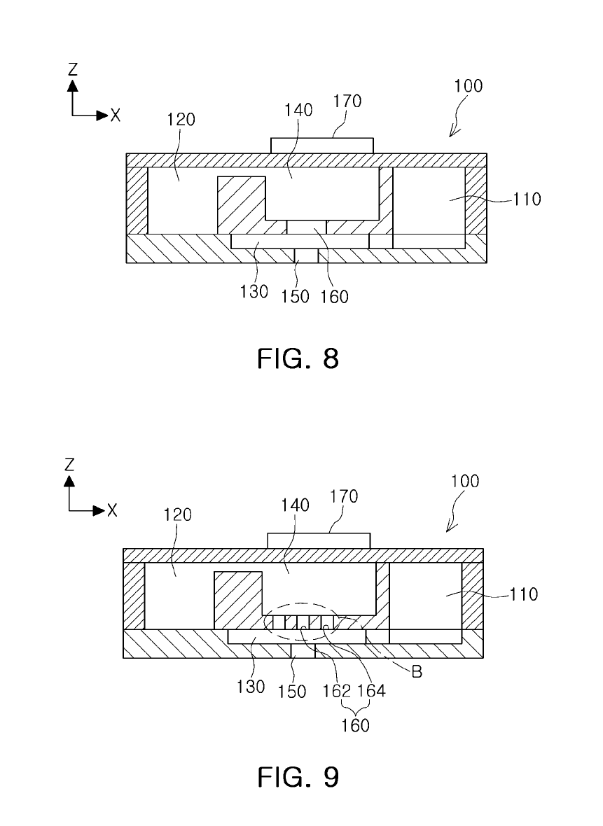

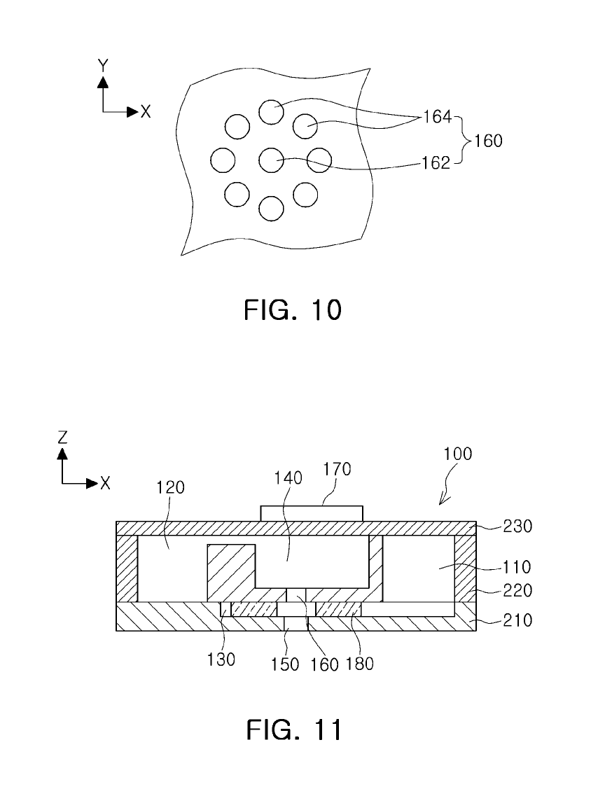

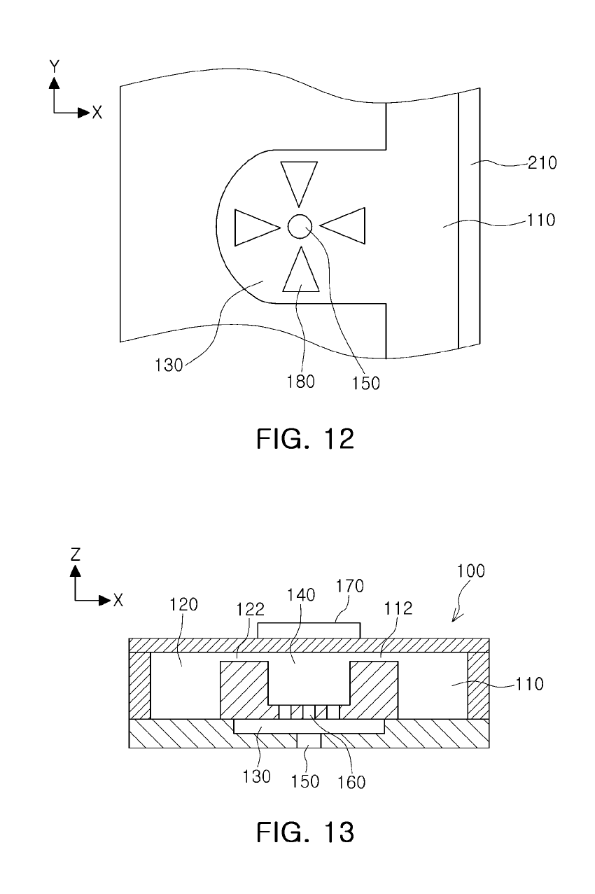

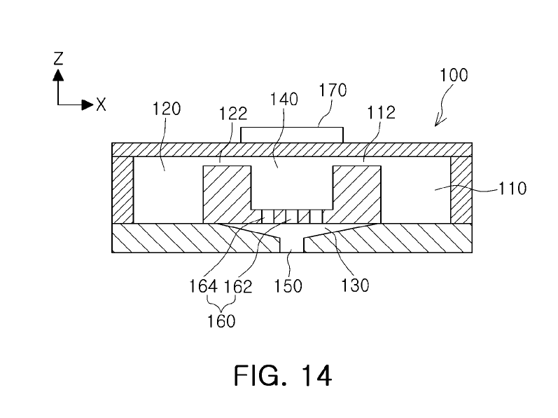

FIG. 1 is an exploded perspective view showing an inkjet print head according to a first embodiment of the present invention, FIG. 2 is an assembled perspective view of the inkjet print head shown in FIG. 1, FIG. 3 is a cross-sectional view taken along line A-A of FIG. 2, FIGS. 4 through 6 are views showing an ink discharging process of the inkjet print head shown in FIG. 1, FIG. 7 is a cross-sectional view showing an inkjet print head according to a second embodiment of the present invention, FIG. 8 is a cross-sectional view showing an inkjet print head according to a third embodiment of the present invention, FIG. 9 is a cross-sectional view showing an inkjet print head according to a fourth embodiment of the present invention, FIG. 10 is a plan view of part B shown in FIG. 9, FIG. 11 is a cross-sectional view showing an inkjet print head according to a fifth embodiment of the present invention, FIG. 12 is a plan view of a lower substrate shown in FIG. 11, and FIGS. 13 and 14 are cross-sectional views showing an inkjet print head according to a sixth embodiment of the present invention.

An inkjet print head according to a first embodiment of the present invention will be described with reference to FIGS. 1 through 6.

An inkjet print head 100 according to the first embodiment of the present invention may include a first channel 110, a second channel 120, a first pressure chamber 130, a second pressure chamber 140, and an actuator 170. Moreover, the inkjet print head 100 may include a lower substrate 210, an upper substrate 220, and a vibration substrate 230 that include the above-described components formed therein. Here, the respective substrates 210, 220, and 230 may be a silicon substrate or a silicon on insulator (SOI) substrate.

The first channel 110 may be formed in the lower substrate 210 and the upper substrate 220. Specifically, the first channel 110 may be formed to be elongated in a first direction (a Y axis direction based on FIG. 1) of the lower substrate 210 and the upper substrate 220. The first channel 110 may supply ink. Specifically, the first channel 110 may be connected to an ink inlet 240 (see FIG. 2) to which the ink is supplied and may supply the ink to the pressure chambers 130 and 140 through the ink inlet 240.

A predetermined first pressure may be formed in the first channel 110. The first pressure may be greater than atmospheric pressure. In addition, the first pressure may be greater than pressure in the first pressure chamber 130 and the second pressure chamber 140. Therefore, the ink stored in the pressure chambers 130 and 140 may be moved to the second channel 120 without flowing backwardly into the first channel 110.

The second channel 120 may be formed in the upper substrate 220. Specifically, the second channel 120 may be formed to be elongated in the first direction of the upper substrate 220. That is, the second channel 120 may be formed in parallel to the first channel 110. The second channel 120 may recover the ink. Specifically, the second channel 120 may be connected to an ink outlet 250, such that it may transport the ink discharged from the second pressure chamber 140 to the outside, as shown in FIG. 2. For reference, the ink discharged from the ink outlet 250 may be supplied to the ink inlet 240 via a filter or the like.

A predetermined second pressure may be formed in the second channel 120. The second pressure may be less than atmospheric pressure. In addition, the second pressure may be less than pressure in the first pressure chamber 130 and the second pressure chamber 140. Therefore, the ink in the pressure chambers 130 and 140 may be discharged to the outside through the second channel 120.

The first pressure chamber 130 may be formed in the lower substrate 210. Specifically, a plurality of first pressure chambers 130 may be spaced apart from the first channel 110 by a predetermined distance, and may be disposed to be spaced apart from each other by a predetermined interval in the first direction (the Y axis direction based on FIG. 1) of the lower substrate 210. Here, each of the first pressure chambers 130 and the first channel 110 may be connected to each other by a first restrictor 112. The first pressure chamber 130 may be provided with a first nozzle 150. The ink contained in the first pressure chamber 130 and the second pressure chamber 140 may be discharged to the outside through the first nozzle 150.

The second pressure chamber 140 may be formed in the upper substrate 220. Specifically, a plurality of second pressure chambers 140 may be spaced apart from the second channel 120 by a predetermined distance, and may be disposed to be spaced apart from each other by a predetermined interval in the first direction (the Y axis direction based on FIG. 1) of the upper substrate 220. Here, each of the second pressure chambers 140 and the second channel 120 may be connected to each other by a second restrictor 122.

The second pressure chamber 140 may have a volume larger than that of the first pressure chamber 130. In this case, driving force (pressure) generated by the actuator 170 may be delivered to the first pressure chamber 130 through the second pressure chamber 140. However, the present invention is not limited to the case in which the volume of the second pressure chamber 140 is larger than that of the first pressure chamber 130.

The second pressure chamber 140 may be provided with a second nozzle 160. The ink and the pressure in the second pressure chamber 140 may be delivered to the first pressure chamber 130 through the second nozzle 160. The second nozzle 160 may be positioned to correspond to the first nozzle 150. Specifically, a center of the second nozzle 160 and a center of the first nozzle 150 may be disposed on the same vertical line. In this case, the ink contained in the second pressure chamber 140 may be easily discharged to the outside through the second nozzle 160 and the first nozzle 150.

The actuator 170 may include a piezoelectric element and upper and lower electrode members. Specifically, the actuator 170 may have a stack structure in which the upper electrode member and the lower electrode member are disposed to have the piezoelectric element interposed therebetween.

The lower electrode member may be formed on an upper surface of the vibration substrate 230 and may be formed of one or more conductive metal materials. For example, the lower electrode member may be formed of two metal members made of titanium (Ti) and platinum (Pt).

The piezoelectric element may be formed on the lower electrode member. Specifically, the piezoelectric element may be thinly formed on a surface of the lower electrode member by a screen printing method, a sputtering method, or the like. The piezoelectric element may be formed of a piezoelectric material. For example, the piezoelectric element may be formed of a ceramic (for example, PZT) material.

The upper electrode member may be formed on an upper surface of the piezoelectric element. The upper electrode member may be formed of any one of materials such as platinum (Pt), gold (Au), silver (Ag), nickel (Ni), titanium (Ti) and copper (Cu).

The actuator 170 configured as described above may be expanded and contracted according to an electrical signal and may generate the pressure in the pressure chambers 130 and 140.

The inkjet print head 100 configured as described above may be extended in one direction as shown in FIG. 2, and may be connected to a device for ink circulation. To this end, the inkjet print head 100 may be provided with the ink inlet 240 and the ink outlet 250. Here, the ink inlet 240 may be connected to an ink tank (not shown) in which the ink is stored, while the ink outlet 250 may be connected to an ink auxiliary tank (not shown) to which the ink is recovered. Meanwhile, the ink tank and the ink auxiliary tank may be connected to each other through a separate connection pipe. The connection pipe may be provided with a pump allowing the ink to circulate smoothly and may be additionally provided with a degassing unit and a filter for removing air bubbles and foreign objects contained in the ink.

The inkjet print head 100 according to the present embodiment may have ink flow as shown in FIG. 3. Specifically, in a state in which the inkjet print head 100 is inactive (ink is not discharged therefrom), a circulation of the ink indicated by a solid line arrow occurs, while in a state in which the inkjet print head 100 is operated (ink is discharged therefrom), a circulation of the ink indicated by a dotted line arrow occurs.

That is, in the state in which the inkjet print head 100 is inactive, the ink supplied through the first channel 110 may be discharged to the second channel 120 via the first pressure chamber 130 and the second pressure chamber 140. Unlike this, in the state in which the inkjet print head 100 is operated, the ink contained in the second pressure chamber 140 and in the first pressure chamber 130 may be discharged to the outside by sequentially passing through the second nozzle 160 and the first nozzle 150.

The inkjet print head 100 according to the present embodiment may have a plurality of pressure chambers 130 and 140 vertically disposed therein, whereby generation of air bubbles may be suppressed and alleviated. This will be described with reference to FIGS. 4 through 6.

In the state in which the inkjet print head 100 is inactive, ink in the first nozzle 150 may have a concave shape toward the pressure chamber 130, as shown in FIG. 4. This ink shape is favorable for discharging ink droplets and has an advantage in that ink may not be discharged, even by an external force.

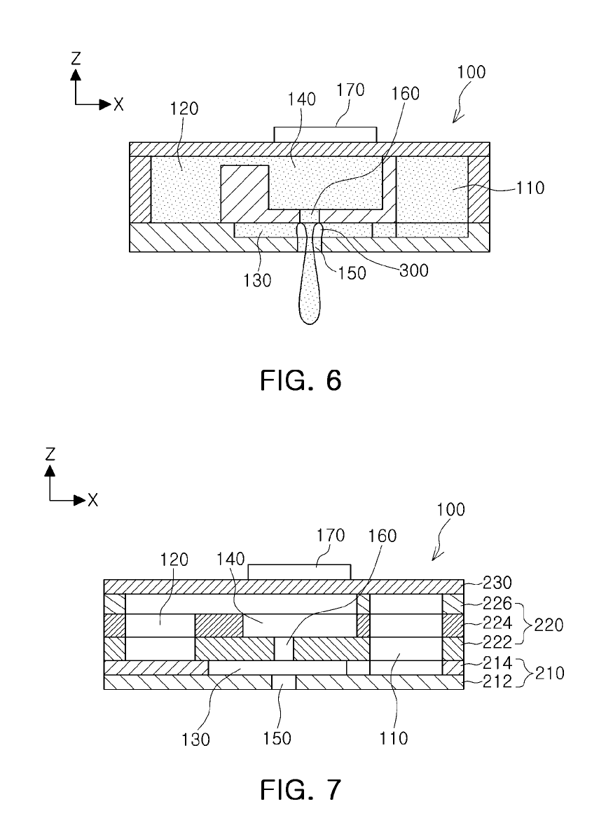

When the inkjet print head 100 is operated in this state, ink may be discharged through the first nozzle 150 as shown in FIG. 5. In addition, when the discharging of ink through the first nozzle 150 reaches maximally appropriate discharging, air may be introduced into the first pressure chamber 130 by repulsive force according to the discharging of ink as shown in FIG. 6. Here, in the inkjet print head according to the related art, the introduced air is transformed into bubbles to thereby block the nozzle or occupy a significant amount of space of the pressure chamber, such that fixed quantity discharge of ink may be interrupted.

However, in the inkjet print head 100 according to the present embodiment, since air 300 is blocked from being introduced deeply into the pressure chambers 130 and 140 as shown in FIG. 6, phenomena in which bubbles are generated by the introduction of the air 300 or the nozzle is obstructed by the generated bubbles may be effectively suppressed.

Moreover, since the inkjet print head 100 according to the present embodiment may have a structure in which the ink is continuously circulated from the first channel 110 to the second channel 120, even when air bubbles are entrapped in the pressure chambers 130 and 140, the inkjet print head 100 may discharge the ink and the bubbles to the outside of the inkjet print head through the second channel 120.

Therefore, according to the present embodiment, performance and quality degradation of the inkjet print head 100 due to bubbles may be effectively prevented, whereby printing performance and quality of the inkjet print head 100 may be improved.

Next, an inkjet print head according to other embodiments of the present invention will be described. In the following embodiments, the components described in the above-described embodiment will be denoted by the same reference numerals and detailed descriptions thereof will be omitted.

An inkjet print head according to a second embodiment of the present invention will be described with reference to FIG. 7.

The inkjet print head 100 according to the present embodiment may be different from the inkjet print head 100 according to the above-described embodiment in that it may include a plurality of substrates. Specifically, the inkjet print head 100 according to the present embodiment may include six substrates including the vibration substrate 230. Specifically, the lower substrate 210 may include a first lower substrate 212 and a second lower substrate 214. Moreover, the upper substrate 220 may include a first upper substrate 222, a second upper substrate 224, and a third upper substrate 226.

The inkjet print head 100 configured as described above may be formed such that the channels 110 and 120, the pressure chambers 130 and 140, the nozzles 150 and 160, and the like, vertically penetrate through the substrates 210 and 220. Therefore, in the present embodiment, etching processing of the substrates 210 and 220 as well as precision processing of the substrates 210 and 220 may be easily performed.

An inkjet print head according to a third embodiment of the present invention will be described with reference to FIG. 8.

The inkjet print head 100 according to the present embodiment may be different from the inkjet print head 100 of the above-mentioned embodiments, in that the first nozzle 150 and the second nozzle 160 have different sizes. Specifically, the size (or a cross-sectional area) of the second nozzle 160 may be larger than that of the first nozzle 150. In this case, ink flow between the first pressure chamber 130 and the second pressure chamber 140 may be smoothly performed and pressure in the second pressure chamber 140 may be effectively delivered to the first pressure chamber 130 through the second nozzle 160.

An inkjet print head according to a fourth embodiment of the present invention will be described with reference to FIGS. 9 and 10.

The inkjet print head 100 according to the present embodiment may be different from the inkjet print head 100 according to the above-described embodiments in the number of holes of the second nozzle 160. Specifically, the second nozzle 160 may include a first hole 162 and second holes 164 as shown in FIG. 10. The first hole 162 may be disposed on the same vertical line as the first nozzle 150 and the second holes 164 may be disposed in a circular manner around the first hole 162. Here, the sizes of the first hole 162 and the second holes 164 may be smaller than that of the first nozzle 150, but an overall cross-sectional area of the first hole 162 and the second holes 164 may be larger than that of the first nozzle 150.

The inkjet print head 100 configured as described above may allow ink to flow smoothly through the plurality of holes 162 and 164. Moreover, since the size of the first hole 162 disposed upwardly of the first nozzle 150 in a vertical direction is smaller than that of the first nozzle 150, it may effectively block air introduced through the first nozzle 150 from being expanded upwardly in the vertical direction.

An inkjet print head according to a fifth embodiment of the present invention will be described with reference to FIGS. 11 and 12.

The inkjet print head 100 according to the present embodiment may be different from the inkjet print head 100 according to the above-described embodiments, in that the first pressure chamber 130 is provided with a resistive structure 180. Specifically, the first pressure chamber 130 may be provided with a plurality of resistive structures 180 as shown in FIG. 12. The resistive structure 180 may have a triangular cross-sectional shape. Specifically, a cross-sectional area of the resistive structure 180 may be narrowed toward the first nozzle 150 from an edge of the first pressure chamber 130. However, the cross-sectional shape of the resistive structure 180 is not limited to the triangular shape as described above, but may be changed to other shapes.

Moreover, in the present embodiment, the first pressure chamber 130 and the second pressure chamber 140 may have roughly circular cross-sections. Specifically, the first pressure chamber 130 may have a circular cross-section around the first nozzle 150 and the second pressure chamber 140 may have a circular cross-section around the second nozzle 160.

Since the inkjet print head 100 configured as described above includes the first pressure chamber 130 having the plurality of resistive structures formed therein, it may effectively block the ink in the first pressure chamber 130 from flowing backwardly into the first channel 110 and the ink pressure-fed from the second pressure chamber 140 to the first pressure chamber 130 by the driving force of the actuator 170 from flowing backwardly into the first channel 110.

An inkjet print head according to a sixth embodiment of the present invention will be described with reference to FIG. 13.

The inkjet print head 100 according to the present embodiment may be different from the inkjet print head 100 according to the above-described embodiments in a circulation structure of ink. Specifically, the circulation of ink in the present embodiment may be performed in the order of the first channel 110, the second pressure chamber 140, and the second channel 120.

In the present embodiment, the first pressure chamber 130 may have a longitudinal section having an inverted triangular shape as shown in FIG. 14. The first pressure chamber 130 having the above-mentioned shape may disperse bubbles generated during the discharging of ink into both ends thereof.

The second pressure chamber 140 may be provided with a plurality of second nozzles 162 and 164. Specifically, the second nozzles 162 and 164 may include a single first hole 162 and a plurality of second holes 164. Here, the first hole 162 is disposed upwardly of the first nozzle 150 in a vertical direction, such that it may be used as a passage through which ink moves. In addition, the second holes 164 are disposed at the edge of the second pressure chamber 140, such that they may be used as a passage through which bubbles in the first pressure chamber move to the second pressure chamber 140.

As set forth above, according to embodiments of the present invention, performance degradation of an inkjet print head due to air bubbles generated during discharging of ink can be efficiently alleviated.

While the present invention has been shown and described in connection with the embodiments, it will be apparent to those skilled in the art that modifications and variations can be made without departing from the spirit and scope of the invention as defined by the appended claims.

1. An inkjet print head, comprising:
a first pressure chamber connected to a first channel and including a first nozzle formed therein; and
a second pressure chamber connected to a second channel and including a second nozzle formed therein, the second nozzle being connected to the first pressure chamber.

2. The inkjet print head of claim 1, wherein the first nozzle and the second nozzle are disposed on the same vertical line.

3. The inkjet print head of claim 1, wherein the second nozzle has a cross sectional area larger than that of the first nozzle.

4. The inkjet print head of claim 1, wherein there is a plurality of the second nozzles.

5. The inkjet print head of claim 1, wherein the second pressure chamber has a volume larger than that of the first pressure chamber.

6. The inkjet print head of claim 1, wherein the second pressure chamber has a height greater than that of the first pressure chamber.

7. The inkjet print head of claim 1, wherein the first channel is connected to an ink inlet supplying ink, and
the second channel is connected to an ink outlet recovering the ink.

8. The inkjet print head of claim 1, further comprising an actuator generating driving force in the second pressure chamber.

9. The inkjet print head of claim 1, wherein the first pressure chamber is provided with one or more resistive structures so as to block ink from flowing backwardly in a direction of the first channel.

10. An inkjet print head, comprising:
a first pressure chamber including a first nozzle formed therein; and
a second pressure chamber connected to a first channel and a second channel and including a second nozzle formed therein, the second nozzle being connected to the first pressure chamber.

11. The inkjet print head of claim 10, wherein the first nozzle and the second nozzle are disposed on the same vertical line.

12. The inkjet print head of claim 10, wherein the second nozzle has a cross sectional area larger than that of the first nozzle.

13. The inkjet print head of claim 10, wherein there is a plurality of the second nozzles.

14. The inkjet print head of claim 10, wherein the second pressure chamber has a volume larger than that of the first pressure chamber.

15. The inkjet print head of claim 10, wherein the second pressure chamber has a height greater than that of the first pressure chamber.

16. The inkjet print head of claim 10, wherein the first channel is connected to an ink inlet supplying ink, and
the second channel is connected to an ink outlet recovering the ink.

17. The inkjet print head of claim 10, further comprising an actuator generating driving force in the second pressure chamber.
